(19) United States
(12) Patent Application Publication
(10) Pub. No.: US 2013/0100667 A1
(43) Pub. Date: Apr. 25, 2013

(54) LIGHT BEACON

(71) Applicants: Mathieu Riendeau, Saint-Constant (CA); Richard Lang, Montreal (CA); Guy Buisson, Coteau-du-Lac (CA); Felix Yu Fan, Montreal (CA); Martin Langlois, La Pocatiere (CA)

(72) Inventors: Mathieu Riendeau, Saint-Constant (CA); Richard Lang, Montreal (CA); Guy Buisson, Coteau-du-Lac (CA); Felix Yu Fan, Montreal (CA); Martin Langlois, La Pocatiere (CA)

(21) Appl. No.: 13/277,599

(22) Filed: Oct. 20, 2011

(51) Int. Cl. F21V 7/06; F21V 7/09

(52) U.S. Cl. 362/240

(57) ABSTRACT

The present disclosure relates to a light beacon. The light beacon comprises a casing and a plurality of light units. Each light unit is disposed along a periphery of the casing. Each light unit comprises a back reflector, two parallel side reflectors and at least one light emitting diode. The back reflector has at least a section defining a parabolic shape. The two parallel side reflectors face each other on opposite sides of the back reflector. The at least one light emitting diode (LED) is positioned about a focal point of the section defining a parabolic shape of the back reflector. The position of the at least one LED with respect to the back reflector determines an angle of projected light beam by the light unit.

### TECHNICAL FIELD

The present disclosure relates to the field of light beacons used for navigation purposes. More specifically, the present disclosure relates to a light beacon with a plurality of light units comprising at least one LED.

### BACKGROUND

Warning lights, also called light beacons are commonly installed to illuminate tall structures that form potential obstacles to air traffic. These light beacons serve to enhance the security of the travelling public. Regulations define requirements for the location of light beacons and also for the characteristics of such light beacons, including color, brightness, spectrum, width of beam, distance etc of emitted light. Because light beacons are frequently installed on structures that are not easily accessible, such as for example antenna towers, and because of the sheer safety hazards stemming from equipment failures, very high reliability requirements are imposed on those products.

Some light beacon applications, especially for daylight uses, require very high intensity, in the hundreds of thousands of candelas. Traditional light beacons capable of producing such light intensity generally produce large amounts of heath. These light beacons are expensive to produce, consume a lot of energy, and suffer from limited lamp life. Requirements on high reliability and on strong light intensity may be somewhat in conflict and may only be attained at high implementation costs.

Therefore, there is a need for improved light beacons.

### BRIEF DESCRIPTION OF THE DRAWINGS

Embodiments of the disclosure will be described by way of example only with reference to the accompanying drawings, in which:

FIG. 1 is a schematic representation of a light unit in accordance with an aspect of the present light beacon;

FIG. 2 is a top schematic top view of 5 emitting light units of FIG. 1, composing a light beacon;

FIG. 3 is a simulation of emitted light rays with an untilted LED;

FIG. 4 is a simulation of emitted light rays with an LED titled inwardly at an angle of 25 degrees;

FIG. 5 is a schematic representation of light beacon;

FIG. 6 is a graphical representation of measurements of vertical profile of the light emission performed by means of the prototype; the vertical axis corresponds to values of effective candelas when LEDs are pulsed at 0.7 amps for a period of 100 ms;

FIG. 7 graphically represents the effective intensity distribution of the prototype; and

FIG. 8 graphically represents theoretically angular distribution, calculated based on experimental results for light units oriented at intervals of 72°.

### DETAILED DESCRIPTION

The foregoing and other features will become more apparent upon reading of the following non-restrictive description of illustrative embodiments thereof, given by way of example only with reference to the accompanying drawings.

Various aspects of the present disclosure generally address one or more of the problems of currently sold light beacons, namely manufacturing cost, high energy consumption, reliability etc.

The following terminology is used throughout the present disclosure:
Light beacon: a source of light for guiding, indicating obstacles and other similar uses.
Light unit: unit comprising a light source and reflective surfaces, to be grouped with other light units to form a light beacon.
LED (light emitting diode): a semiconductor light source, available in various colors and brightness levels.
Parabola: two-dimensional shape obtained by transecting a regular cone, the shape following equation (1):

y=ax²+bx+c (1).
Parabolic cylinder: three-dimensional shape obtained by projecting a two-dimensional parabola linearly on an orthogonal axis.

Reflector: a surface that reflects light, such as a for example a mirror.

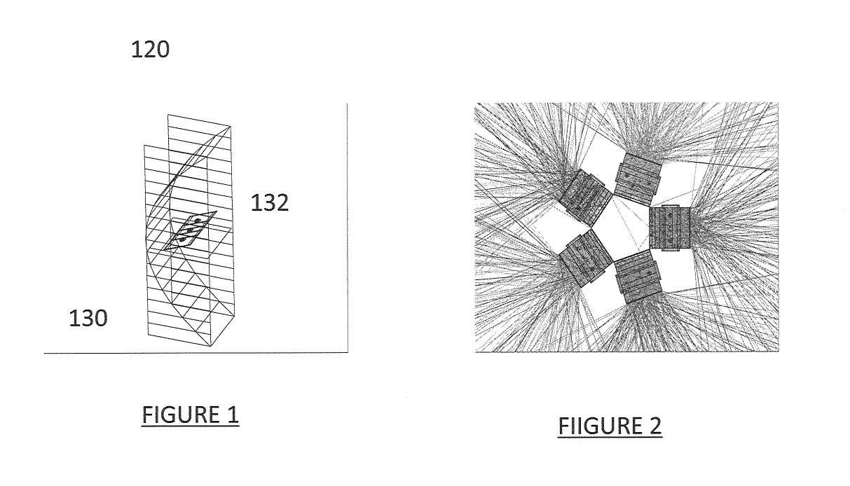

Referring now to the drawings, FIG. 1 is a schematic perspective view of a light unit according to an embodiment. Typically, several light units 100 are included in a light beacon. An exemplary disposition of the light units 100 in the light beacon will be depicted further.

The light unit 100 comprises a back reflector 120. At least a part of the back reflector 120 has a substantially parabolic shape. The parabolic shape may be in a vertical plane or a horizontal plane of the light unit 100, depending of the desired direction of the resulting light beam. In a particular embodiment, the back reflector 120 has a cylindrical parabolic shape, where the parabolic section is vertical so as to produce a narrow vertical light beam with a wide horizontal width. Furthermore, so as to reduce size of the light unit 100, the back reflector 120 may define about half of the parabolic shape.

The light unit 100 also comprises two parallel side reflectors 130, 132. The side reflectors 130, 132 face each other on opposite sides of the back reflector 120. The parallel side reflectors are located so as to redirect the light rays that are generated on each side within the back reflector, thereby increasing efficiency of the light unit.

The light unit 100 further comprises at least one light emitting diode (LED) 150. The at least one LED 150 is positioned about a focal point of the section defining a parabolic shape of the back reflector 120. In a particular embodiment, the light unit 100 comprises three LEDs 150 aligned along the length of the parabolic shape of the back reflector. To increase efficiency, the three LEDs 150 are installed about the focal point of the parabolic shape of the back reflector. Those skilled in the art will recognize that the LEDs do not need to be exactly at the focal point of the parabolic shape of the back reflector, but that closer proximity of the focal point provides better efficiency of the reflected light. However, as it is difficult during construction to have perfect alignment of the three LEDs with the focal point of the parabolic shape, the design of the present light unit provides less stringent tolerance with respect to the positioning of the LEDs with respect to the focal point. Furthermore, the position of the at least one LED 150 with respect to the back reflector also determines an angle of a generated light beam by the light unit 100, and an angle of projection of the latter. Thus, by carefully selecting position of the at least one LED 150, it is possible to adjust the angle of the generated light beam at the horizon, and the angle of projection of the latter by the light beacon, so as to correspond to various requirements of the light beacon industry. The present light unit 100 is thus by its intricate design of back reflector, side reflectors and position of at least one LED, a flexible solution to provide power efficient, cost efficient light beacons for various standards by simple adjustment of the position of the at least one LED within the light unit.

A transparent window 170 may further be provided to each light unit 100. The transparent window 170 may face the back reflector 120 and allows light generated by the LED 150 and reflected by the back reflector 120 and parallel side reflectors 130 to be emitted from the light unit. Alternately, the transparent window 170 may be provided around the casing in which the light units are installed.

The back reflector 120 and the two parallel side reflectors 130 and 132 may consist of any type of reflective material. This particular configuration of back reflector with at least a section defining a parabolic shape, two parallel side reflectors facing each other on opposite sides of the back reflector, and at least one LED positioned about a focal point provides a very efficient light unit, capable of emitting light with a narrow beam along an axis, and a wide beam in a perpendicular axis, and which can be produced at reasonable costs.

As previously indicated, the light unit 100 may comprise one or several LEDs 150. Several LEDs may be used concurrently to generate a specific color of light not available in a single LED, for example, several LEDs of various colours may be used concurrently in the light unit 100 so that a blend of those various colours provides a white light of desired color and intensity. Several LEDs may further be used concurrently to increase the intensity of the light generated by the light unit 100, such as for example a plurality of white LEDs. In a particular embodiment, two LEDs 150 may be used alternatively, such as a white LED and a red LED, so as to provide, with the same light unit, a white light during the day, and a red light during the evening and night. In yet another variant, one or several of the LEDs in the light unit 100 may be actuated in such a manner as to generate a stroboscopic effect.

Those of ordinary skill in the art will appreciate that light emitting and light focusing effectiveness of the light unit do not require a perfect implementation of the above-described parabolic shapes and location of the LED(s) at the focal point thereof. Variations from a pure, mathematically defined parabolic shape may result from design constraints or from manufacturing tolerances. Likewise, parallelism between side reflectors may be less than perfect, for the same reasons. Additionally, some deviation from a pure parabolic shape, from perfect parallelism or from perfect orthogonality of some components of the light unit may be desired, for example for adjusting a horizontal or vertical beam coverage angle of the light unit.

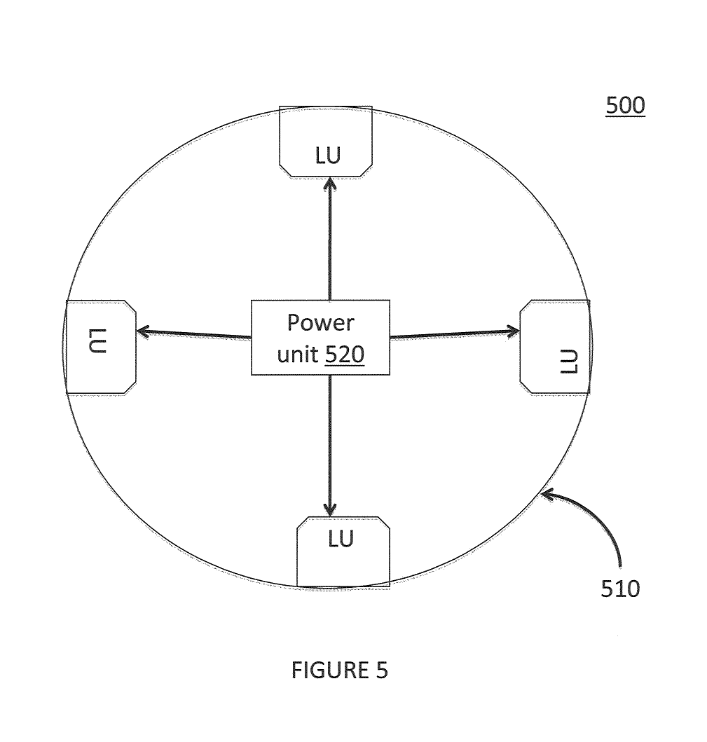

Turning now to FIG. 5, there is shown a schematic representation of a light beacon comprising a plurality of light units (LU), disposed in a casing and electrically connected to a power unit. Each light unit is disposed along a periphery of the casing, so as to project light away from the casing. Although only four light units are shown on FIG. 5, the present light beacon is not limited to such a number of light units. In fact, the present light beacon 500 could comprise fewer or more light units, and even a series of co-adjacent light units. In fact, in a specific aspect, the light beacon comprises seven light units, which has proven to provide an efficient light uniformity over a fully circle defined by the light beacon. The casing 510 could be round, polygonal, square, rectangular, or of any suitable shape and size. The casing 510 protects the light units from environmental conditions and harsh elements. The casing 510 may be made of metal, alloy or any other sturdy material known and used in the beacon industry.

The light beacon 510 further comprises a power unit 520. The power unit 520 is also affixed in the casing 510, and is in electric connection with the light units. The power unit 520 receives electricity from any suitable source such as for example: the power grid, batteries, solar panel, windmill, generator, etc. The power unit 520 is further adapted to control the light units. For doing so, the power unit 520 provides electricity and actuates the light units of interest. For example, the light beacon 500 may comprise a number of light units producing white light, and a number of light units producing red light. Thus during the day, the power unit 520 provides electricity and actuates only the light units producing white light, while during the night, the power unit 520 provides electricity and actuates only the light units producing red light.

As LEDs typically function at different voltages and currents than readily available from ordinary power sources, the power unit 510 may further comprise a transformer (not shown), for transforming the electricity received from the power source to a voltage and current appropriate for the LEDs of the light units.

Simulations further confirmed that various factors influence efficiency of the light units. Examples of those factors include back reflector parabolic curvature radius, length of the back reflector, truncation of the extremities of the parabolic back reflector, positioning of the LED(s) and angle of the LED(s). With respect to the back reflector parabolic curvature radius, a trade off between efficiency and size of the light unit is required.

In a particular embodiment, so as to produce light units of reasonable size with high light refection efficiency, the back reflector was built with a curvature radius of 90 mm, with a length of 80 mm, so as to allow use of 3 spaced LEDs in each light unit. Reducing the length of the back reflector to 60 mm reduces light propagation efficiency by about 2%. Truncation of the extremities of the parabolic back reflector at 80 mm, provides light units of reasonable dimensions with reasonable efficiency. It is however possible to truncate the extremities of the parabolic back reflector to 95 mm so as to increase efficiency by 5%, while truncating the extremities at 60 mm reduces efficiency by 10%. Positioning of the LEDs at the focal point of the back reflector is significant for both efficiency and light uniformity distribution. For example, light propagation efficiency for LEDs located at 1.5 mm from the focal point reduces light propagation efficiency by 15%. Thus positioning the LEDs at ±0.5 mm from the focal point provides better light propagation efficiency. Turning now to the orientation of the LEDs with respect to the parabolic axis of the back reflector, a deviation of ±5 degrees results in a reduction of light transmission efficiency of about 1%.

The present light unit configuration thus allows generating light of a high intensity in a vertically narrow beam, with very little light lost outside of the beam of interest, in a wide horizontal beam, at reduced costs.

### Prototype

A prototype of light unit was built to test and validate the expected performances. Criteria which were considered for the design of the prototype included energy efficiency, design simplicity, dimensions and production costs.

For each light unit, a configuration using three aligned LEDs was implemented. The LEDs were selected based on the following criteria: power, emitted angular distribution, dimensions and costs. The selected LED was a LECW E3B (O-Star™) from OSRAM™, which comprises 6 light emitters of 1 mm×1 mm, separated by a 0.1 mm spacing. This LED emits light in a quasi-lambertian configuration.

In all simulations, a light detector was placed at a distance of 100 meters of the light unit, at a height of 5 meters, so as to calculate efficiency of the light unit at an angular interval of 3 degrees at the horizon.

The back reflector used was a cylindrical parabolic mirror reflector. The cylindrical parabolic mirror provided a narrow vertical light beam with a broad horizontal light beam. Simulations were performed on various cylindrical parabolic mirror reflector dimensions and shapes, so as to identify an optimal optical collimating of the light rays emitted by the LEDs. Based on those simulations, a cylindrical parabolic mirror reflector measuring 80 mm in length was selected. Extremities of the cylindrical parabolic mirror reflector were truncated so that the overall cylindrical parabolic mirror reflector measured 80 mm×80 mm.

Flat mirrors were affixed facing each another on the extremities of the cylindrical parabolic mirror reflector, so as to redirect light rays emitted in the direction of the extremities. The flat mirrors optimized the efficiency of the cylindrical parabolic mirror reflector, while reducing substantially its size.

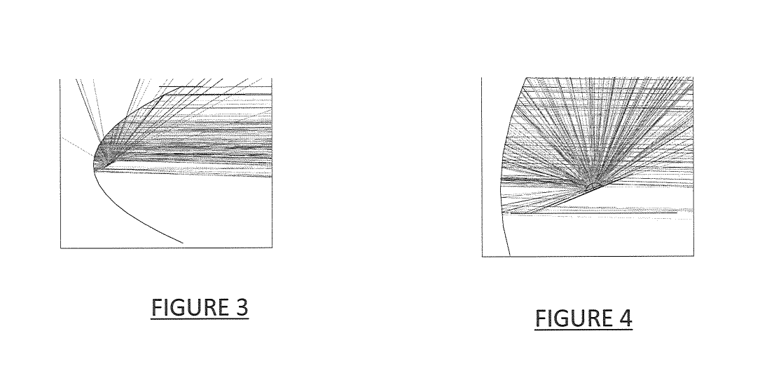

Furthermore, only an upper portion of the parabola of the parabolic reflector was used so as to reduce dimensions of the light unit. It was noticed that a greater number of rays could be collimated when the LEDs was tilted inward at a 25 degree angle with respect to the parabola's axis, as shown on FIG. 4, compared to untitled LEDs as shown on FIG. 3.

The light units were then assembled into a light beacon in a configuration as shown on FIG. 2. In this configuration, the simulation proved that although there would be intensity variations between light coverage areas provided by each light unit, such light variations were of about 5% only.

The LEDs were then powered with pulses of 0.7 amps of a duration of 100 ms. By means of a (PLEASE TRANSLATE goniomètre), instantaneous illumination value in lux was measured at different angles: −90° to +90° in increments of 3° over an horizontal plane, and at angles between −3.5° and +3.5° in increments of 0.5° over a vertical plane. Measurements were also taken at an angle of 10° over the vertical axis, so as to verify the emitting of light under the horizon. The measurements were then multiplied by a factor d², where d corresponds to a distance separating the prototype from the detector, so as to obtain the value of the instantaneous light intensity in candela. Finally, the effective light intensity was calculated for each measurement using the following equation:

$${I}_{Effectif} = \frac{1}{0.2 + ( {t}_{2} - {t}_{1} )} {\int }_{{t}_{1}}^{{t}_{2}} \text{?} d t$$

$$\text{?} \text{indicates text missing or illegible when filed}$$

which considers human eye response to light. As T₂−t₁=100 ms, the equation may be rewritten as follows:

$${I}_{Effectif} = \frac{\text{?}}{3} . \\ \text{?} \text{indicates text missing or illegible when filed}$$

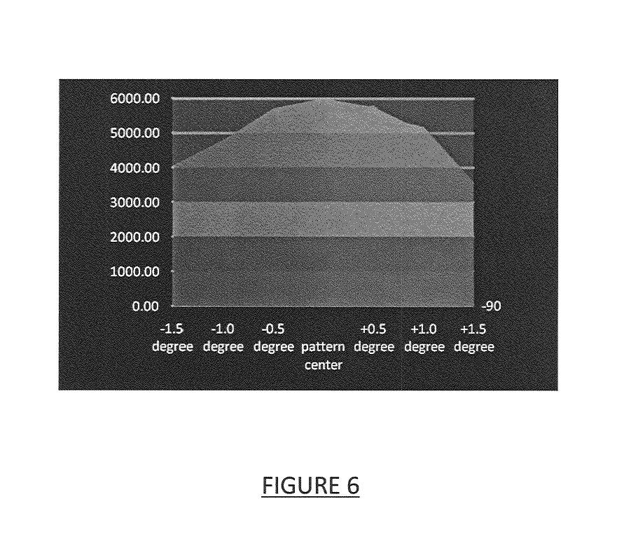

Reference is now made to FIG. 6, which graphically represents the effective light intensity as measured facing one light unit. The maximum effective light intensity is located at the center, while the values calculated at −1.5° and at +1.5° on the vertical are superior to 50% of the maximum measurement.

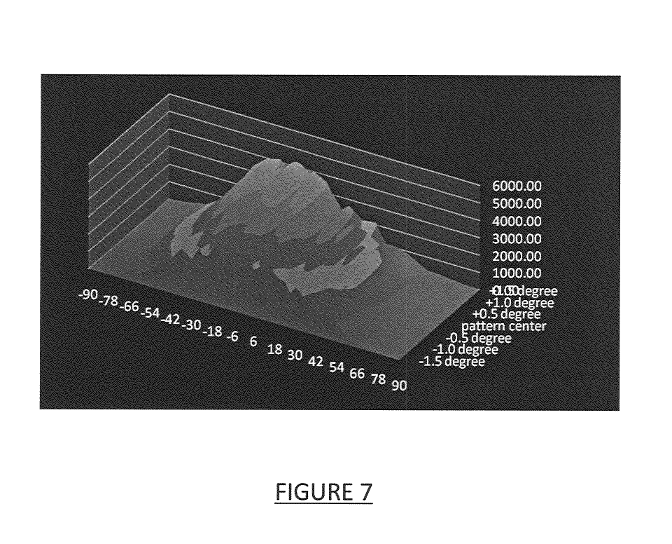

Reference is now concurrently made to FIG. 7, which graphically represent the effective intensity distribution of the prototype. Although the measured intensity quickly reduces along the horizontal axis, there is light emitted from −90° to +90°.

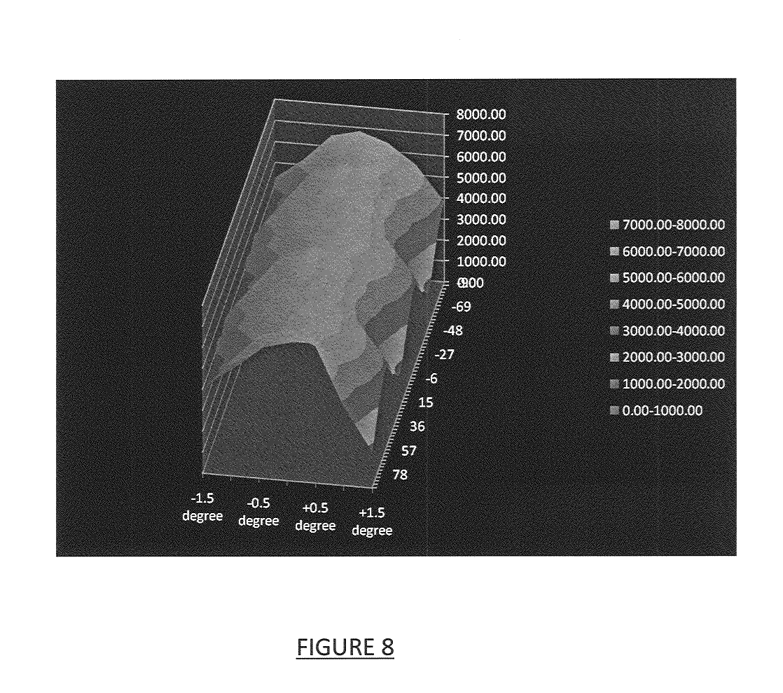

Bu using 5 light units with partially superposed emitted light, at intervals of for example 72°, it is possible to obtain a uniform light distribution, as shown on FIG. 8, which has a greater effective maximum light intensity than when the emitted light beams are not partially superposed.

Those of ordinary skill in the art will realize that the description of the light unit and light beacon is illustrative only and is not intended to be in any way limiting. Other embodiments will readily suggest themselves to such persons with ordinary skill in the art having the benefit of the present disclosure. Furthermore, the disclosed light unit and light beacon may be customized to offer valuable solutions to existing needs and problems of light beacons and their manufacturing.

Although the present light beacon has been described hereinabove by way of non-restrictive, illustrative embodiments thereof, these embodiments may be modified at will within the scope of the appended claims without departing from the spirit and nature of the present disclosure.

What is claimed is:

1. A light beacon comprising:
a casing; and
a plurality of light units, each light unit being disposed along a periphery of the casing; each light unit comprising:
a back reflector having at least a section defining a parabolic shape;
two parallel side reflectors, the side reflectors facing each other on opposite sides of the back reflector; and
at least one light emitting diode (LED) positioned about a focal point of the section defining a parabolic shape of the back reflector,
wherein position of the at least one LED with respect to the back reflector determines an angle of projected light beam.

2. The light beacon of claim 1, wherein at lest one of the light units comprises a plurality of LEDs.

3. The light beacon of claim 2, wherein the plurality of LEDs comprise a plurality of white LEDs.

4. The light beacon of claim 2, wherein the plurality of LEDs comprise LEDs of various colors, wherein a blend of the various colors provides white light.

5. The light beacon of claim 1, wherein the section defining a parabolic shape of the back reflector is a cylindrical parabolic shape.

6. The light beacon of claim 1, wherein the section defining a parabolic shape of the back reflector is a half parabolic cylinder spanning between the two side reflectors.

7. The light beacon of claim 1, wherein at least one of the LEDs produces a strobe light.

8. The light beacon of claim 1, wherein the back reflector and parallel side reflectors are covered with a reflective film.

9. The light beacon of claim 1, wherein some of the light units comprise a white LED, while others of the light units comprise a red LED.

10. The light beacon of claim 1, wherein the light generated by the plurality of light units has the following parameters: maximum intensity of at least 15000 candelas, intensity of about 50% of the maximum intensity at vertical angles of −1.5° to +1.5°.

11. The light beacon of claim 1, wherein the light units are disposed in such a manner as to provide a uniform light beam there around.
